(19) United States
(12) Patent Application Publication
(10) Pub. No.: US 2015/0308823 A1
(43) Pub. Date: Oct. 29, 2015

(54) COMPUTING APPARATUS AND METHOD

(71) Applicant: JAGUAR LAND ROVER LIMITED, Coventry, Warwickshire (GB)

(72) Inventors: Paul WIDDOWSON, Kenilworth, Warwickshire (GB); Anna GASZCZAK, Coventry, Warwickshire (GB)

(21) Appl. No.: 14/431,242

(22) PCT Filed: Sep. 25, 2013
(86) PCT No.: PCT/EP2013/069978

§ 371 Date: Mar. 25, 2015

(30) Foreign Application Priority Data
Sep. 25, 2012 (GB) 1217104.7

(51) Int. Cl. G01C 11/02; G06T 11/60

(52) U.S. Cl. CPC G01C 11/02; G06T 11/60

(57) ABSTRACT

Embodiments of the invention provide computing apparatus for determining a height of a roof load of a vehicle, the apparatus being operable to: display a captured image of at least a portion a the vehicle and roof load on display means of the apparatus; superimpose a vehicle overlay on the image; and allow a user to manipulate the vehicle overlay thereby to obtain a prescribed correspondence between the overlay and the at least a portion of the vehicle, wherein the apparatus is further operable to calculate a height of the roof load and to provide an output corresponding to the calculated height.

### FIELD OF THE INVENTION

The present invention relates to an apparatus for measuring a height of an object. In particular but not exclusively the invention relates to an apparatus for measuring a height of a roof load of a motor vehicle. Aspects of the invention relate to an apparatus, to a method to a code, to a storage medium and to a vehicle.

### BACKGROUND

Collision of vehicles with overhead obstacles is a known problem particularly for high sided vehicles such as trucks. In order to reduce a risk of collision it is known to attach a radar device to the vehicle. The radar device scans an environment ahead of the vehicle for potential collision hazards. If such a hazard is detected the device sounds an alert to a driver of the vehicle.

It is desirable to provide a solution to this problem that is convenient for use by motor vehicle drivers such as private cars or automobiles that may carry different roof loads at different times.

### STATEMENT OF THE INVENTION

Embodiments of the invention may be understood with reference to the appended claims.

Aspects of the present invention provide an apparatus, a method, computer program code, a computer readable storage medium and a vehicle.

In an aspect of the invention for which protection is sought there is provided computing apparatus for determining a height of a roof load of a vehicle, the apparatus operable to:
display a captured image of at least a portion of the vehicle and roof load on display means of the apparatus;
superimpose a vehicle overlay on the image, wherein at least a first dimension of the vehicle overlay corresponds to a known dimension of the vehicle; and
allow a user to manipulate the vehicle overlay thereby to obtain a prescribed correspondence between at least the first dimension of the overlay and the at least a portion of the vehicle,
wherein the apparatus is further operable to calculate a height of the roof load and to provide an output corresponding to the calculated height.

Embodiments of the present invention have the advantage that a height of a roof load may be determined with accuracy in a convenient manner. It is to be understood that the ability to determine accurately a roof load height may assist a vehicle operator in reducing a risk of collision of the vehicle with an overhead obstacle such as a bridge or other structure. Since the first dimension of the overlay corresponds to a known dimension of the vehicle, other dimensions within the captured image can be calculated. It may be that the vehicle overlay corresponds a plurality of dimensions which correspond to known dimensions of the vehicle. The apparatus may be operable to allow a user to manipulate the vehicle overlay thereby to obtain a prescribed correspondence between some or all of the dimensions of the overlay and the at least a portion of the vehicle.

It is to be understood that the output corresponding to the calculated height may be in the form or a visual output, an audible output, or in the form of a signal. For example the apparatus may provide the output in the form of a digital transmission via a wired or wireless link. The output may be in the form of a data stream, a data packet or any other suitable signal.

Advantageously the apparatus may be operable to allow the user to manipulate the vehicle overlay by translation, expansion and compression thereof in at least two non-parallel directions.

Further advantageously the apparatus may be operable to display a predetermined vehicle overlay corresponding to the make and model of the vehicle displayed in the image.

The apparatus may be operable to determine the make and model of the vehicle by reference to one selected from amongst make and model data input by a user; a unique vehicle identifier input by a user such as a license plate number or vehicle identification number (VIN); and a unique vehicle identifier determined by the apparatus from an image by optical character recognition.

Advantageously the vehicle overlay may comprise an image or representation of at least a portion of the vehicle, optionally a wire frame image.

Advantageously the apparatus may be operable to allow the user to provide an indication of a location of an upper boundary of the roof load on the displayed image by requesting the user to position a roof load overlay over the portion of the image corresponding to the roof load.

The roof load overlay may comprise a wire frame image.

The apparatus may be operable automatically to detect a location of the roof load from the captured image. The apparatus may be operable automatically to detect the location of an upper boundary of the roof load on the displayed image, for example by optical analysis of the image.

Optionally the apparatus is operable to allow the user to provide an indication of a location of an upper boundary of the roof load on the displayed image by requesting the user to confirm that the location of the roof load as determined automatically by the apparatus is correct.

Advantageously the apparatus may be operable to request a user to switch on one or more illumination means of the vehicle before an image of the vehicle is captured.

This feature has the advantage that contrast between features of the vehicle may be enhanced thereby to facilitate alignment of the overlay.

Further advantageously the apparatus may be operable to request a user to switch on one or more illumination means of the vehicle when it is determined that a contrast between features of a captured image is below a threshold level.

The apparatus may be operable to request a user to switch on one or more illumination means of the vehicle when it is determined that one or more features of a vehicle are not detectable in a captured image.

The apparatus may further comprise means for capturing the image of a vehicle.

The apparatus may comprise means for communication with computing means of a vehicle thereby to provide data corresponding to a height of a roof load of the vehicle.

The apparatus may be operable to provide data corresponding to a height of a roof load of the vehicle by one selected from amongst a wireless link, optionally a short range radio connection such as Bluetooth®, a short message service (SMS) communication, an email and a wired link.

In a further aspect of the invention for which protection is sought there is provided a vehicle having computing means operable to communicate with apparatus according to any preceding aspect of the invention, the vehicle being operable to receive data corresponding to a height of a roof load of the vehicle from the apparatus.

The vehicle may be operable to provide an indication to a user of the height of the roof load responsive to the data received from the apparatus.

Advantageously the vehicle may be operable to provide an indication whether a roof load has a height exceeding one or more prescribed values.

The vehicle may be operable to communicate an actual height of the roof load to a driver by one selected from amongst a visual indication and an audible indication.

In one aspect of the invention for which protection is sought there is provided a vehicle according to the preceding aspect in combination with apparatus according to a preceding aspect.

In a still further aspect of the invention for which protection is sought there is provided a method of determining a height of a roof load of a vehicle comprising:
receiving and displaying a captured image of at least a portion of the vehicle on display means of a computing apparatus;
superimposing a vehicle overlay on the image, wherein at least a first dimension of the vehicle overlay corresponds to a known dimension of the vehicle; and
receiving an input from a user and changing an appearance of the vehicle overlay responsive to the input from the user whereby the user manipulates the overlay to obtain a prescribed correspondence between at least the first dimension of the vehicle overlay and the image,
the method further comprising calculating a height of the roof load and providing an output corresponding to the calculated height.

In an aspect of the invention for which protection is sought there is provided computer program code arranged to implement a method according to the preceding aspect when executed by computing apparatus.

In one aspect of the invention for which protection is sought there is provided a computer readable storage medium having stored therein computer program code by means of which computing apparatus may implement the method of an aspect of the invention.

In one aspect of the invention for which protection is sought there is provided computing apparatus for determining a height of a roof load of is vehicle, the apparatus being operable to:
display a captured image of at least a portion of the vehicle on display means of the apparatus;
superimpose a vehicle overlay on the image, wherein at least a first dimension of the vehicle overlay corresponds to a known dimension of the vehicle;
allow the user to manipulate the vehicle overlay thereby to obtain a prescribed correspondence between at least the first dimension of the overlay and the at least a portion of the vehicle in the image; and
allow the use to provide an indication of a location of an upper boundary of the roof load on the image,
wherein the apparatus is further operable to calculate a height of the roof load according to the position of the upper boundary of the roof load and a position and shape of the vehicle overlay, the apparatus being operable to provide an output corresponding to the calculated height.

In an aspect of the invention for which protection is sought there is provided a method of determining a height of a roof load of a vehicle comprising:
receiving and displaying a captured image of at least a portion of the vehicle on display means of a computing apparatus;
superimposing a vehicle overlay on the image, wherein at least a first dimension of the vehicle overlay corresponds to a known dimension of the vehicle;
receiving an input from a user and changing an appearance of the vehicle overlay responsive to the input from the user whereby the user manipulates the overlay to obtain a prescribed correspondence between at least the first dimension of the vehicle overlay and the image; and
receiving an input from the user in respect of a location of an upper boundary of the roof load on the image,
the method further comprising calculating a height of the roof load responsive to the position of the upper boundary of the roof load and a position and shape of the vehicle overlay and providing an output corresponding to the calculated height.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

One or more embodiments of the invention will now be described, by way of example only, with reference to the accompanying figures in which:

FIG. 1 shows (a) a mobile smartphone device running a software application according to an embodiment of the present invention; and (b) a scenario in which a user employs a smartphone according to an embodiment of the present invention to capture an image of a vehicle having a roof load;

FIG. 2 shows (a) an example of an image of a vehicle with roof load captured by the apparatus of FIG. 1; (b) an image of a vehicle overlay having shape elements corresponding to prominent features of the particular make and model of the vehicle shown in (a); (c) a screenshot from the apparatus of FIG. 1 showing the vehicle overlay of (b) superimposed on the image of (a) prior to manipulation by the user; and (d) a screenshot from the apparatus of FIG. 1 showing the vehicle overlay of (b) superimposed on the image of (a) after manipulation by the user to match the corresponding features of the vehicle; and

FIG. 3 shows (a) a load definition overlay in the form of a wire frame representation of a rectangular box; (b) the load definition overlay superimposed on the image of FIG. 1(a) following manipulation by the user to enclose the roof load of the vehicle; (c) a screenshot from the apparatus showing only the vehicle and roof load overlays; and (d) a screenshot from the apparatus showing the result of the determination of vehicle roof load height.

### DETAILED DESCRIPTION

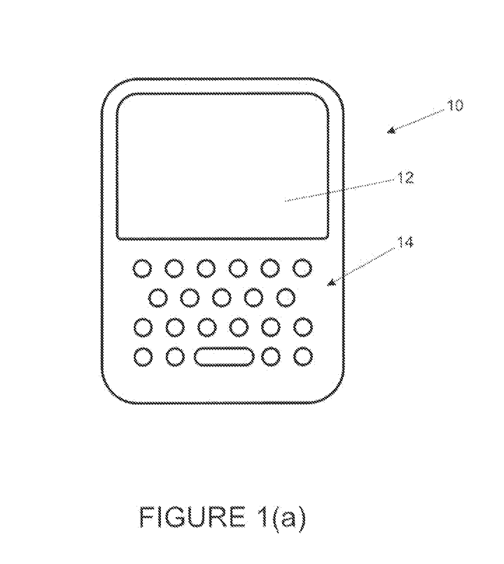

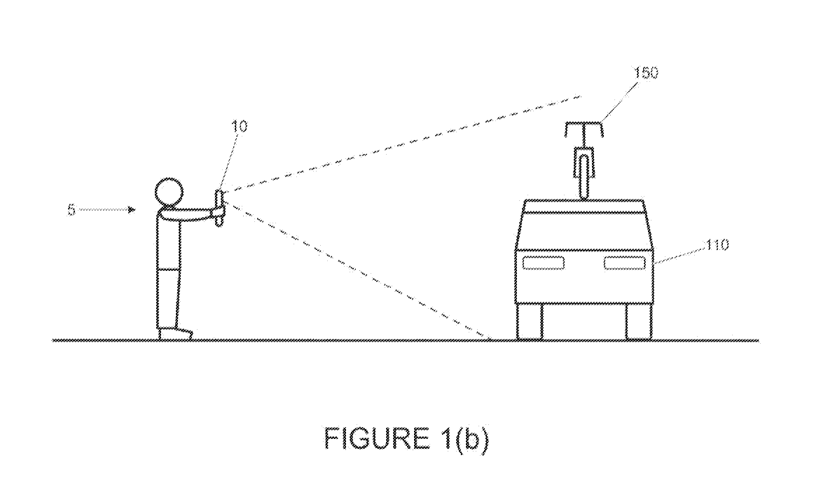

In one embodiment of the invention a mobile telecommunications apparatus 10 is provided in the form of a smart phone device 10 shown in FIG. 1(a) operable to run user downloadable software applications (or ‘apps’). The device 10 is loaded with a software application that is configured to control the device 10 to measure is height of a roof load 150 of a motor vehicle 110 (FIG. 1(b)). The software application is configured to determine the height based on an image of the vehicle 110 and roof load 150 provided to it. In the embodiment of FIG. 1(a) the application is operable to employ an image captured by the smart phone device 10 itself. In some alternative embodiments the apparatus may be arranged to receive from an external source an image of a vehicle for processing, for example by means of a telecommunications network, a removable data storage device or any other suitable means.

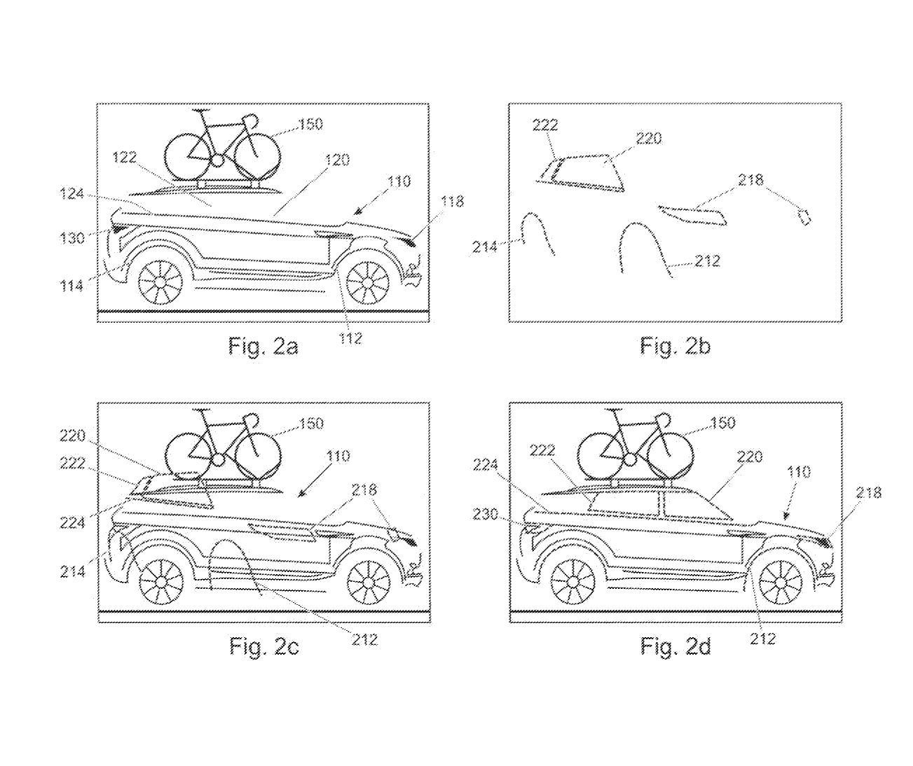

FIG. 1(b) shows a scenario in which user 5 controls the device 10 to capture an image of the vehicle 110 with roof load 150 for use by the software application. FIG. 2(a) shows an example of an image of a vehicle 110 with roof load 150 as captured by the device 10 and displayed on a screen thereof.

After capturing an image of the vehicle 110 with roof load 150 the device 10 is configured to request a user to input data corresponding to a make and model of the vehicle 110. Responsive to this data the device 10 displays a vehicle overlay 210 on a screen 12 of the device 10 corresponding to the selected make and model of the vehicle 110. In the present embodiment the vehicle overlay 210 is in the form of a wire frame image representing a virtual model of the selected vehicle. A screen shot taken from the display 12 of the device 10 at this stage is shown in FIG. 2(b).

In the present embodiment illustrated in FIG. 2 the vehicle overlay 210 includes a representation of a select number of prominent features of the selected vehicle including an outline of front and rear wheel arches 212, 214, front and rear lighting clusters 218, 230, front and rear door window panels 220, 222 and door window seal stripes 224.

The device 10 is then configured to superimpose the vehicle overlay 210 on the image of the vehicle 110 that was captured by the user. A screenshot taken from the display 12 of the device 10 at this stage is shown in FIG. 2(c).

The device 10 is configured to allow a user to input commands to the device 10 to rotate, resize and translate the vehicle overlay 210 until the features of the vehicle 110 provided by the overlay 210 are directly superimposed on the corresponding features of the vehicle 110 in the captured image. FIG. 2(d) is a screenshot taken from the device 10 following manipulation of the overlay 210 in this manner.

In some embodiments the device 10 has a touch-sensitive display (touchscreen) 12 and is configured to allow manipulation of the overlay 210 to be performed by prescribed gestures input to the device 10 via the touchscreen. In addition or instead, in some embodiments the device 10 may be configured to allow the user to input commands to manipulate the overlay 210 by means of a keypad 14 of the device 10. Other arrangements are also useful.

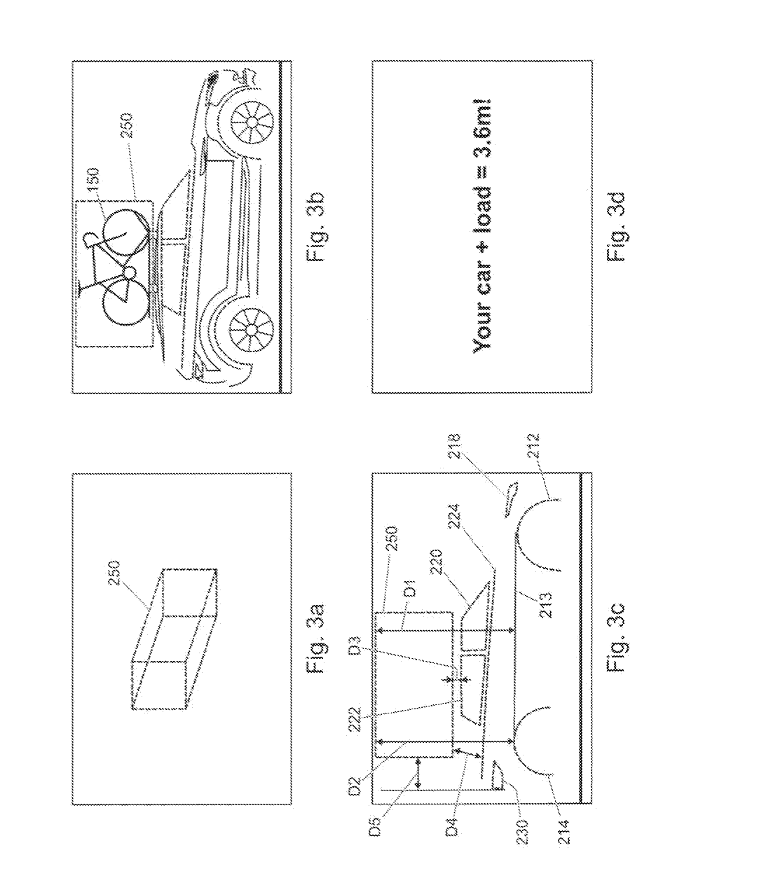

After performing the vehicle overlay 210 alignment procedure described above the user is presented with a roof load overlay 250 in the form of a wire frame image of a box. The user is requested to manipulate the image so as to enclose within the box of the roof load overlay 250 the portion of the captured image containing the roof load 150. FIG. 3(a) is a screenshot taken from the device 10 when displaying the roof load overlay 250 only.

FIG. 3(b) is a screenshot taken from the device 10 showing the captured image with the vehicle overlay 210 and roof load overlay 250 following manipulation by the user of the roof load overlay 250. It can be seen that the portion of the captured image corresponding to the roof load 150 is enclosed within the roof load overlay 250.

The user is then requested by the device 10 to confirm that they are satisfied that the vehicle overlay 210 and roof load overlay 250 correctly overlie the corresponding features of the captured image. Once this confirmation is provided the device 10 is configured automatically to determine the distance between prescribed reference points of the vehicle 110 and corresponding prescribed reference points of the roof load overlay 250 as if the roof load overlay 250 were a physical object on the vehicle. In the present embodiment the distances D1, D2, D3, D4, and D5 of FIG. 3(c) are measured automatically by the device 10 with respect to the actual vehicle by means of standard trigonometry. It is to be understood that the device 10 is provided with data corresponding to the actual size and relative heights above ground of each of the features of the vehicle overlay with respect to an actual vehicle. The device 10 is configured to determine the heights D1 and D2 of the upper limit of the roof load 150 above the window strips 124 at prescribed positions.

Dimension D3 corresponds to a vertical distance between an upper edge of the rear door window 122 and a lower edge of the wire frame box image of the roof load overlay 250 at a prescribed position of the door window 122. Dimension D4 corresponds to a distance between the door seal strip 124 and the lower edge of the wire frame box image of the roof load overlay 250 at a prescribed position whilst dimension D5 corresponds to a horizontal distance between a rearmost edge of the rear lighting cluster 130 and the rearmost edge of the wire frame box image of the roof load overlay 250.

The device 10 therefore determines an absolute height above ground of an upper limit of the roof load 150 by determining the value of distances D1 and D2 and adding to each distance a height above ground of the waistline of the vehicle at the prescribed positions. The value of the height above ground is output as an absolute height measurement as illustrated in the screenshot shown in FIG. 3(d).

It with be readily apparent to the skilled person that in some embodiments the device 10 may be configured to determine the heights D1 and D2 of the upper limit of the roof load 150 with respect to alternative or additional features of the vehicle 110 at prescribed positions, for example above the door window stripe 124 of the vehicle at the prescribed positions. In this case, the device 10 therefore determines an absolute height above ground of an upper limit of the roof load 150 by determining the value of distances D1 and D2 and adding to each distance a height above ground of the door window stripe 124 of the vehicle at the prescribed positions.

It is to be understood that in some embodiments the device 10 may compare dimensions of features of the overlays 210, 250 in a captured image along respective axes, for example along respective orthogonal axes such as respective horizontal and vertical axes. The device 10 may for example compare a horizontal length and vertical height of a given feature such as a door window 120, 122 in order to determine a tilt of the device 10 about a horizontal axis. The device 10 may subsequently employ this information to generate a 3D model of the size and position of the roof load 150 (as defined by the roof load overlay 250) with respect to the vehicle 100 in order to determine the absolute height above ground of an upper limit of the roof load 150.

In some embodiments the apparatus 10 may be configured to request a user to switch on one or more illumination lamps of the vehicle 110 such as one or more interior or exterior lamps. Thus if the apparatus 10 determines that the contrast between two or more features of the vehicle 110 is inadequate, or that one or more features are not detectable for example due to low lighting conditions, the apparatus 10 may request the one or more lamps to be illuminated. In some embodiments the particular vehicle overlay displayed may be responsive to a determination whether or not a user has switched on one or more lamps. For example, in the case where a plurality of overlays are available for a particular vehicle and one or more of the overlays includes a lamp or lighting cluster, the apparatus 10 may be operable to select such an overlay. Similarly, if an outline of one or more windows may be enhanced by switching on interior illumination a user may be requested to switch on such illumination and be provided with an overlay having one or more features corresponding to one or more windows of the vehicle. The apparatus 10 may be operable to select such an overlay automatically or in response to a user input.

In the embodiment described above, the user provides an indication of the location of the roof load by manipulating a roof load overlay 250. In an alternative embodiment, the device 10 is arranged to automatically detect the height of the load by analysing the captured image.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith.

1. An apparatus for determining a height of a roof load of a vehicle, the apparatus being operable to:
display a captured image of at least a portion of the vehicle and roof load on display means of the apparatus;
superimpose a vehicle overlay on the image, wherein at least a first dimension of the vehicle overlay corresponds to a known dimension of the vehicle; and
allow a user to manipulate the vehicle overlay thereby to obtain a prescribed correspondence between at least the first dimension of the overlay and the at least a portion of the vehicle;
wherein the apparatus is further operable to calculate a height of the roof load and to provide an output corresponding to the calculated height.

2. An apparatus as claimed in claim 1 wherein the apparatus is operable to allow the user to manipulate the vehicle overlay by translation, expansion and compression thereof in at least two non-parallel directions.

3. An apparatus as claimed in claim 1 wherein the apparatus is operable to display a predetermined vehicle overlay corresponding to the make and model of the vehicle displayed in the image.

4. An apparatus as claimed in claim 3 operable to determine the make and model of the vehicle by reference to one selected from amongst make and model data input by a user; a unique vehicle identifier input by a user such as a license plate number or vehicle identification number (VIN); and a unique vehicle identifier determined by the apparatus from an image by optical character recognition.

5. An apparatus as claimed in claim 1 wherein the vehicle overlay comprises a wire frame or other image of at least a portion of the vehicle.

6. An apparatus as claimed in claim 1 operable to allow the user to provide an indication of a location of an upper boundary of the roof load on the displayed image by requesting the user to position a roof load overlay over the portion of the image corresponding to the roof load.

7. An apparatus as claimed in claim 6 wherein the roof load overlay comprises a wire frame image.

8. An apparatus as claimed in claim 1 wherein the apparatus is operable automatically to detect a location of the roof load from the captured image.

9. An apparatus as claimed in claim 1 operable to allow the user to provide an indication of a location of an upper boundary of the roof load on the displayed image.

10. An apparatus as claimed in claim 9 wherein the apparatus is operable automatically to detect a location of the roof load from the captured image and wherein the apparatus is operable to allow the user to provide an indication of a location of an upper boundary of the roof load on the displayed image by requesting the user to confirm that the location of the roof load as determined automatically by the apparatus is correct.

11. An apparatus as claimed in claim 1 operable to request a user to switch on one or more illumination means of the vehicle.

12. An apparatus as claimed in claim 11 operable to request a user to switch on one or more illumination means of the vehicle when it is determined that a contrast between features of a captured image is below a threshold level.

13. An apparatus as claimed in claim 10 operable to request a user to switch on one or more illumination means of the vehicle when it is determined that one or more features of a vehicle are not detectable in a captured image.

14. An apparatus as claimed in claim 1 further comprising means for capturing the image of the vehicle.

15. An apparatus as claimed in claim 1 comprising means for communication with computing means of a vehicle thereby to provide data corresponding to a height of a roof load of the vehicle to the computing means.

16. An apparatus as claimed in claim 15 wherein the communication of data corresponding to a height of a roof load of the vehicle is via a wired link or via a short range radio connection, a short message service (SMS) communication, or an email.

17. A vehicle having computing means operable to communicate with an apparatus according to claim 1, the vehicle being operable to receive data corresponding to a height of a roof load of the vehicle from the apparatus.

18. A vehicle as claimed in claim 17 operable to provide an indication to a user of the height of the roof load responsive to the data received from the apparatus.

19. A vehicle as claimed in claim 18 operable to provide an indication whether a roof load has a height exceeding one or more prescribed values.

20. A vehicle as claimed in claim 18 operable to communicate an actual height of the roof load to a driver by one selected from amongst a visual indication and an audible indication.

21. A vehicle as claimed in claim 17 in combination with the apparatus.

22. A method of determining a height of a roof load of a vehicle comprising:
receiving and displaying a captured image of at least a portion of the vehicle on display means of a computing apparatus;
superimposing a vehicle overlay on the image, wherein at least a first dimension of the vehicle overlay corresponds to a known dimension of the vehicle; and
receiving an input from a user and changing an appearance of the vehicle overlay responsive to the input from the user whereby the user manipulates the overlay to obtain a prescribed correspondence between at least the first dimension of the vehicle overlay and the image,
the method further comprising calculating a height of the roof load and providing an output corresponding to the calculated height.

23. Computing apparatus for determining a height of a roof load of a vehicle, the apparatus being operable to:
display a captured image of at least a portion of the vehicle on display means of the apparatus;
superimpose a vehicle overlay on the image, wherein at least a first dimension of the vehicle overlay corresponds to a known dimension of the vehicle;
allow a user to manipulate the vehicle overlay thereby to obtain a prescribed correspondence between at least the first dimension of the overlay and the at least a portion of the vehicle in the image; and
allow the user to provide an indication of a location of an upper boundary of the roof load on the image,
wherein the apparatus is further operable to calculate a height of the roof load responsive to the position of the upper boundary of the roof load and a position and shape of the vehicle overlay, the apparatus being operable to provide an output corresponding to the calculated height.

24. A method according to claim 22, the method comprising:
receiving an input from the user in respect of a location of an upper boundary of the roof load on the image; and
calculating a height of the roof load responsive to the position of the upper boundary of the roof load and a position and shape of the vehicle overlay and providing an output corresponding to the calculated height.

25. (canceled)

26. A computer readable storage medium having stored therein computer program code by means of which the computing apparatus may implement the method of claim 22.

27. (canceled)
